(19) United States
(12) Patent Application Publication
(10) Pub. No.: US 2012/0002840 A1
(43) Pub. Date: Jan. 5, 2012

(54) METHOD OF AND ARRANGEMENT FOR LINKING IMAGE COORDINATES TO COORDINATES OF REFERENCE MODEL

(75) Inventors: Andreas Christianus Linnenbank, Zaandam (NL); Peter Michael van Dam, Arnhem (NL)

(73) Assignee: Cortius Holding B.V.

(21) Appl. No.: 13/113,009

(22) Filed: May 20, 2011

Related U.S. Application Data
(63) Continuation of application No. PCT/NL2009/050711, filed on Nov. 23, 2009.

(30) Foreign Application Priority Data
Nov. 21, 2008 (EP) EP08169673.4

(51) Int. Cl. G06K 9/00

(52) U.S. Cl. 382/103

(57) ABSTRACT

A method of linking image coordinates to coordinates in a reference model is disclosed. The method includes acquiring a 2½D or 3D input image representing a body of a living being and including at least two image boundaries of at least two parts within said body, acquiring a 3D reference model representative of a reference living being describing in a reference model coordinate system at least two reference boundaries of the at least two parts within said body, and overlaying the reference model and the input image. The method further includes adjusting at least a portion of one of the reference boundaries and/or at least one of the image boundaries such that this reference boundary and this image boundary substantially coincide, while the adjusted reference boundary does not intersect with the remaining reference boundaries and/or the adjusted image boundary does not intersect with the remaining image boundaries.

### FIELD OF THE INVENTION

The present invention relates to the field of processing images. In an embodiment, the invention also relates to the field of matching images of 3D anatomical volumes to reference volume models.

### BACKGROUND OF THE INVENTION

In many cases data from various imaging modalities have to be combined. A typical example is in so called inverse computations, where the activation sequence and other parameters of the heart are estimated from surface electrocardiograms. This procedure needs at least the geometry of the heart, lungs and thorax, but preferably more detailed information as well to come to a reliable diagnosis. The cardiac imaging techniques that are used in clinical practice cover the heart, but do not allow for a sufficiently detailed reconstruction of the lungs and thorax from these imaging data alone. What is needed is a method to combine individual patient specific data with general physiological knowledge.

In the same field of inverse computations, every heart constructed is unique. As yet no standardized heart geometries exist. The hearts of different patients vary in number of nodes and connectivity.

When modeling a patient, special conditions like the fact that the lungs and the heart can not intersect in real space have to be taken into account. As an example, a part of the left lung has an approximately constant distance to the left ventricular free wall. With present day techniques, such conditions have to be imposed by hand on a case by case basis.

The models used at present include surface descriptions using a widely varying number of triangles and volume descriptions by means of cubes, tetrahedrons, and hexahedrons. For some of the applications the description of the surface or the volume has to be extended with a description of the internal structures (such as fiber orientation, conduction system, or blood vessels). Some may also require additional meshes to be defined, like lungs and the body surface.

Presently, an approximate model can be constructed in a few days. An individual model that incorporates the realistic geometry of all organs may take weeks or even months to create. For the use of models in clinical practice and the verification of clinically obtained measurements this time is far too long. For experimental procedures creating the model should take at most an hour. To be useful in routine clinical practice the geometries have to be reconstructed even faster.

The consequence of the fact that different meshing techniques have to be used for various computations is that results obtained in one application, e.g. inverse modeling of cardiac activation times, can not easily be used for another application, e.g. for mechanical deformation during the heart cycle. The combination of different analyses results is only possible when the heart models used can be matched.

There are many software tools that can deform meshes. Most of these are aimed at generating surface descriptions for the visible parts only and can't deal with internal organs. It is also hard to find one that will handle every kind of surface and volume description used in our groups (i.e. triangular and quadrangular meshes, tetrahedrons, hexahedrons etc.). It should be possible to deform a set of various descriptions of the hearts at the same time, thereby providing models of which analyses results can be compared. For example, if one 300-vertex triangulation of the heart is matched to an MRI data set, the corresponding 2400-vertex description should be matched automatically. Moreover, defining the fiber orientation changes inside the deformed ventricular wall should be possible in the same system, and a deformation should be easily repeatable with an improved version of the mesh. Another requirement is that one should be able to impose physiological constraints like moving the left ventricular free wall without changing its thickness and its distance to the left lung.

One of the problems encountered when trying to generate a patient-specific model from imaging data is that not every organ is scanned completely, let alone that the whole torso is scanned. MRI imaging takes much time and CT uses radiation. Only slices that are necessary for the clinical evaluation are therefore recorded. As a result, a standard procedure does not provide enough slices to reconstruct the body surface or the lungs and other internal organs. For example, a cardiac MRI normally only has slices that cut through the heart and some adjacent slices. As a result, the right shoulder may not even be visible in any of the slices. Such image data does not provide sufficient information to derive a volume conduction model for use in surface algorithms that relate surface potentials to electrical events within the body, such as ECG, EEG, EMG and MCG.

### SUMMARY OF THE INVENTION

The present invention seeks to provide a framework where for every patient an individual model can be derived from sensed data, such as MRI images, X-ray images, Ultrasound data, which individual model can be expressed in generic coordinates that will be the same for every model and for every patient.

According to the invention, the method of linking coordinates of an image to coordinates of a reference model, the method comprising the steps:

a) acquiring a 2½D or 3D input image representing a body of a living being and including at least two image boundaries of at least two parts within said body in an image reference system, coordinates in the image having a relationship with a real world reference system;

b) acquiring a 3D reference model representative of a reference living being describing in a reference model coordinate system at least two reference boundaries of the at least two parts within said body;

c) overlaying the reference model and the input image; and

d) adjusting at least a portion of one of the reference boundaries and/or at least one of the image boundaries such that this reference boundary and this image boundary substantially coincide, while the adjusted reference boundary does not intersect with the remaining reference boundaries and/or the adjusted image boundary does not intersect with the remaining image boundaries.

It will be appreciated that an image according to the present invention can be a 2½D-image, i.e. a stack of 2D slices, or a 3D-image wherein each pixel represents a volume, i.e. a voxel.

The invention is based on the recognition that for routine clinical application of volume conduction based methods it is necessary that the patient specific adaptations can be done fast and that comparison of electrical phenomena at the corresponding positions in different patients and control groups is vital. Furthermore, it is very time consuming to make a new mesh providing a model of a patient. However, every patient has substantially the same composition but with different sizes and thus different relative positions in real world coordinates. The idea is to link coordinates of an image to coordinates in a reference model by means of, e.g. a number of consecutive, image transformations. By means of the transformations every point in the reference model has an unique point in the image space or real world space. Alternatively, by means of the transformations every point in the image space or real world space has a unique point in the reference model. This enables us to use one specific reference model, for example the boundary of the body, for all patients. This reference model can be transformed into a surface model that approximates the body of the patient. Having such a reference model enables us to add different meshes or models to the same part of a body. Furthermore, the relation of the different models of parts is known as they all use the same reference model coordinate system.

Optionally, the method further includes transforming a portion of the reference model and/or a portion of the input image according to the adjustment of the adjusted reference boundary and/or according to the adjustment of the adjusted image boundary.

It will be appreciated that preventing the adjusted reference boundary to intersect with the remaining reference boundaries and/or preventing the adjusted image boundary to intersect with the remaining image boundaries has the advantage that in the model and/or in the image points that are immediately on either side of the boundary are also immediately on either side of the adjusted boundary in the transformed model and/or the transformed image. It will be appreciated that if such boundaries were to intersect, derived models, such as a volume electrical conduction model might fail due to the presence of multiple conduction values at a single location.

Optionally, the step d) includes checking whether the adjusted reference boundary intersects with the remaining reference boundaries and/or the adjusted image boundary intersects with the remaining image boundaries; and if an intersection is detected re-adjusting said adjusted reference boundary and/or said adjusted image boundary until no intersection is detected.

Optionally, said re-adjusting includes reducing a translation and/or rotation of said adjusted reference boundary and/or said adjusted image boundary. It will be appreciated that a scaling operation such as inflating or deflating locally also is described as translation and/or rotation. Alternatively, or additionally, said re-adjusting includes adjusting a larger portion of said adjusted reference boundary and/or said adjusted image boundary. The latter re-adjusting may prove useful for reducing high local bending which may cause intersection. It will be appreciated that the re-adjusting may be performed automatically, e.g. by an algorithm arranged to achieve an optimum overlay possible without intersection.

Optionally, the step of adjusting includes determining a translation vector required to pre-match the reference boundary and the associated image boundary, and then determine a transformation, such as a, e.g. local, scale factor and/or rotation to match the reference boundary and the associated image boundary.

Optionally, the translation vector is determined by determining virtual connecting strings between, e.g. all, contour points of the reference boundary and nearest points on the associated image boundary, and minimizing tension on the strings. It is possible that a contour point of the reference boundary is connected to only one nearest points on the associated image boundary. It is also possible that a contour point of the reference boundary is connected to a plurality of nearest points on the associated image boundary. It is also possible that a plurality of contour point of the reference boundary is connected to a single nearest points on the associated image boundary. In the latter two cases the tension on the strings may e.g. be averaged. It will be appreciated that other methods of determining the translation vector may be used such as a least squares method.

In an embodiment, the input image further represents an image boundary of the body of the living being, the reference model further describes a reference boundary of the body of the reference living being, and the method includes prior to step d):

e) overlaying the reference boundary of the body and the image boundary of the body;

f) adjusting at least a portion of the reference boundary of the body and/or the image boundary of the body such that this reference boundary and this image boundary substantially coincide;

g) transforming a portion of the reference model and/or a portion of the input image according to the adjustment of the adjusted reference boundary of the body and/or according to the adjustment of the adjusted image boundary of the body.

Optionally, the input image further represents an image boundary of a structure of the living being, said structure including the at least two parts, the reference model further describes a reference boundary of a structure of the reference living being, said structure including the at least two parts, and the method includes prior to step d), preferably after performing steps e), f) and g):

h) overlaying the reference boundary of the structure and the image boundary of the structure;

i) adjusting at least a portion of the reference boundary of the structure and/or the image boundary of the structure such that this reference boundary and this image boundary substantially coincide;

j) transforming a portion of the reference model associated with the reference boundary of the structure and/or a portion of the input image associated with the image boundary of the structure according to the adjustment of the adjusted reference image boundary of the structure and/or the adjusted image boundary of the structure.

The method can briefly be described as overlaying the boundary of a larger piece, e.g. the structure or the body of the reference model and an image. Adjusting the boundaries defining this larger piece such that the boundaries associated with this larger piece in the reference model and in the image substantially coincide, and then transforming the area of the image defined by this boundary to correspond to the same dimensions in the reference model space or transforming the area of the reference model defined by this boundary to correspond to the same dimensions in the image space. Then the same procedure is repeated for a smaller piece, e.g. the structure or at least one part of the body.

In an embodiment, the reference model comprises a first structural element representative of the boundary of the body and at least two second structural elements representative of the boundaries of the at least two parts. The first and second structural elements have control elements associated therewith. The control elements have predefined coordinates in the reference model coordinate system and define the boundary of the associated structural element in the reference model coordinate system. The step of overlaying e) includes overlaying the control elements and the corresponding reference boundary of the structural element representative of the body on the input image, and assigning coordinates in the image reference system to the control elements. The step f) includes adjusting of the coordinates of the control elements associated with said structural element in the image reference system. The step g) includes a transformation to transform the image area corresponding to the adjusted overlaid reference boundary to obtain a transformed image, the transformed image having coordinates in a transformed image coordinate system, wherein the transformed image coordinate system corresponds to the reference model coordinate system and the image portions associated with the coordinates of the overlaid reference boundary being projected to the predefined coordinates of the corresponding boundary of the structural element in the reference model coordinate system. The step d) includes adjusting an overlaid reference boundary of the structural elements of at least one part of the reference model over the transformed image to approximate the image boundary of that part within the body in the transformed image by adjusting coordinates of control elements associated with the structural element representative of that part in the reference model in the transformed image coordinate system. The method further includes a transformation wherein image portions associated with coordinates of the adjusted overlaid reference boundary of said part are projected in the transformed image to the predetermined coordinates of the corresponding boundary of the structural element representative of the boundary of said part in the reference model coordinate system.

This method can briefly be described as overlaying the largest structural element of reference model over an image. Adjusting the boundaries defining the largest structural element such that the boundary approximates the corresponding boundary in the input image and then transforming the area defined by the boundary to correspond to the same dimensions in the reference model space. Then the same procedure is repeated for a lower level of sub elements of which the composition corresponds to the area of the largest element.

Alternatively, the control elements have predefined coordinates in the image reference system and define the boundary of the associated structural element in the image reference system. In this case, the step of overlaying e) includes overlaying the control elements and the corresponding reference boundary of the structural element representative of the body on the input image, and assigning coordinates in the reference model coordinate system to the control elements. The step f) includes adjusting of the coordinates of the control elements associated with said structural element in the reference model coordinate system. The step g) includes a transformation to transform the model area corresponding to the adjusted overlaid reference boundary to obtain a transformed model, the transformed model having coordinates in a transformed model coordinate system, wherein the transformed model coordinate system corresponds to the image reference system and the model portions associated with the coordinates of the overlaid reference boundary being projected to the predefined coordinates of the corresponding boundary of the structural element in the image reference system. The step d) includes adjusting an overlaid reference boundary of the structural elements of at least one part of the transformed model over the input image to approximate the image boundary of that part within the body in the transformed model by adjusting coordinates of control elements associated with the structural element representative of that part in the reference model in the transformed model coordinate system. The method further includes a transformation wherein model portions associated with coordinates of the adjusted overlaid reference boundary of said part are projected in the transformed model to the predetermined coordinates of the corresponding boundary of the structural element representative of the boundary of said part in the image reference system.

Optionally, the reference model comprises a third structural element representative of the boundary of the structure having control elements associated therewith. It will be appreciated that these control elements may be overlaid over the input image similarly as explained with respect to the above embodiment and its alternative. The model portions or image portions may also be transformed similarly as explained with respect to the above embodiment and its alternative.

In an embodiment of the invention, the step of transforming uses tri-cubic interpolation methods. Cubic equations are preferred because it is the lowest order for which continuity can be guaranteed and the curvature at the control points can be controlled.

In one embodiment, the control elements are Bezier control points and the first and second transformation is based on a Bezier transformation. Bezier formulation of controlling the cubic splines was chosen because it is intuitive, creating smooth curves and surfaces is easy because of the control of the derivatives. Further the chances of inadvertently creating self-intersecting curves and surfaces is less than for instance with interpolating splines or with Hermite descriptions because you have to position control points far from the initial position for that to happen. Hence, Bezier formulation allows for easily ensuring that the adjusted reference boundary does not intersect with the remaining reference boundaries and/or the adjusted image boundary does not intersect with the remaining image boundaries.

In a further embodiment of the invention, the largest structural element of the reference model is represented by a unit cube which is associated with the boundary of the body. The largest structural element comprises an assembly of smaller structural elements, the unit cube being divided in smaller sub cubes, wherein each sub cube is assigned to one smaller structural element and a part within the body is associated with one or more sub cubes. These features provide a very structured and simple structure of structural elements to describe the reference model. This ensures that volumes of dedicated models associated with a structural element will not intersect (in real world coordinates of a patient) with volumes of dedicated models of structural elements adjacent to said structural element. The use of a unit cube as the reference space follows logically from the conventional Bezier description. Cutting parallel to sides enables a simple bounding box approach for finding the smallest body part in the model reference space that a specific point belongs to.

In an embodiment, the largest structural element defines a boundary which boundary represents an approximation of the boundary of the body and the boundary of an assembly of one or more sub cubes represents an approximation of the boundary of a part within the body. This is a very suitable structure for a reference model for a patient.

In an embodiment, a part within the body has one or more associated reference meshes describing a boundary of said part in the reference model coordinate system. Defining the models and meshes in a reference space enables application of said meshes and models to all patients for which a transformation from patient space to reference space has been defined.

In an embodiment, a part within said body comprises a sub-part and a structural element representative of said part is a composition of sub structural elements, a sub structural element comprises control elements associated with a boundary representative of said sub part, the method further comprises:
a sub adjustment to adjust an overlaid boundary of the sub structural elements over the transformed image to approximate the boundary of said sub part within the body in the transformed image by adjusting coordinates of control elements associated with the sub structural element representative of the sub-part;
a sub transformation wherein the image area in the transformed image associated with the structural element comprising the sub part is processed and the edge of said image part remains unchanged in the transformed image and wherein image parts associated with coordinates of the adjusted overlaid boundary of the sub part are projected in the transformed image to the predetermined coordinates of the corresponding boundary of the sub structural element in the reference model coordinate system. The adjustment and transformation actions can be repeated on sub-sub-elements which composition corresponds to the total area of one of the sub elements. An advantage of this method is that with every transformation the sub-parts within the structural element that is transformed are positioned in the transformed image more accurately at the position of the structural elements of said sub-parts within the reference model. This simplifies the adjustment of the boundary of the sub-parts in the transformed image. This makes the method according to the invention very intuitive and easy to handle. Furthermore, this makes the method suitable to find the boundaries of parts in the image automatically and to fit the overlaid boundary automatically.

Another advantage is that the applied transformation in the image area of a structural element to transform a sub-structural element does extend to the boundary of the image area of said structural element. Consequently, the image parts outside said boundary remains unchanged. This implies a stacked transformation, wherein the number of stacked transformations depends on the number of layers of structural elements used to obtain the transformed image.

In an embodiment, the method further comprises storing data defining the first and second transformation to enable transformation of spatial models associated with the reference model to real world coordinates to provide an anatomical model for the living being in real world coordinates. Storing patient specific transformation data and linking it to the reference model, enables us to create a new model for a structural element and to verify the new model for every patient based on the transformation data. Furthermore, the amount of data related to a patient can be reduced as, for example, a specific mesh for a part of the body has to be stored only once.

In an embodiment, the reference model comprises further electrical characteristics of respective part within the body, whereby the method further comprises determining a volume conduction model for use in algorithms that relate surface potentials to electrical event within the body. Because a reference based model can be used for every patient, more effort can be made available to develop a more accurate model. This enables us to provide a patient specific model based on more accurate reference based models. This allows us to generate, by means of the inverse transformation, a more accurate electrical description of the patient for us in ECG, EEG, EMC and MCG analysis algorithms.

The whole body of volunteers can be scanned. A good solution would be to scan one or more subjects in great detail and use the derived reconstruction as a patient-specific description. This implies that the mesh will not be constructed from scratch from the MRI data but that a generic mesh is used and deformed until it fits the data.

It is another object of the invention to provide a computer implemented system for mapping an image to a reference model, the system comprising a processor and memory connected to the processor, the memory comprising a computer program comprising data and instructions arranged to allow said processor to perform any of the methods according to the invention.

It is yet a further object of the invention to provide a program product in a computer readable medium for use in a data processing system for mapping an image to a reference model, the computer program product comprising instructions arranged to allow a processor to perform any of the methods according to the invention.

According to the invention, a method of linking coordinates of an image to coordinates of a reference model is provided, the method comprising:

a) acquiring an input image representing a boundary of a body of a living being and a boundary of at least one part within said body in an image reference system, coordinates in the image having a relationship with a real world reference system;

b) acquiring a reference model representative of a reference living being describing in a reference model coordinate system the boundary of the body of the reference living being and the boundary at least one part within said body, wherein the reference model comprises structural elements representative of the boundary of the body and the at least one part, a structural element having associated control elements, the control elements having predefined coordinates in the reference model coordinate system and defining the boundary of the structural element in the reference model coordinate system;

c) overlaying control elements and corresponding boundary of the structural element representative of the body on the input image, and assigning coordinates in the image reference system to the control elements;

d) a first adjustment to adjust the overlaid boundary of the structural element representative of the body on the input to approximate the boundary of the body of the living being in the input image by adjusting the coordinates of the control elements associated with said structural element in the image reference system;

e) a first transformation to transform the image area corresponding to the adjusted overlaid boundary to obtain an transformed image, the transformed image having coordinates in a transformed image coordinate system, wherein the transformed image coordinate system corresponds to the reference model coordinate system and the images parts associated with the coordinates of overlaid boundary being projected to the predefined coordinates of the corresponding boundary of the structural element in the reference model coordinate system;

f) a second adjustment to adjust an overlaid boundary of the structural elements of the at least one part of the reference model over the transformed image to approximate the boundary of the at least one part within the body in the transformed image by adjusting coordinates of control elements associated with the structural element representative of the at least one part in the reference model in the transformed image coordinate system;

g) a second transformation wherein image parts associated with coordinates of the adjusted overlaid boundary of the at least one part are projected in the transformed image to the predetermined coordinates of the corresponding boundary of the structural element representative of the boundary of the at least one part in the reference model coordinate system

### SHORT DESCRIPTION OF DRAWINGS

The invention will be explained in detail with reference to the drawings that are only intended to show embodiments of the invention and not to limit the scope. The scope of the invention is defined in the annexed claims and by its technical equivalents.

FIG. 1a shows a flow chart of a first example of a basic process according to the invention;

FIG. 1b shows a flow chart of a second example of a process according to the invention;

FIGS. 2a-2d illustrate schematically the mapping of an image to a reference model;

FIGS. 3a-3d illustrate schematically an implementation of a method according to the invention;

FIG. 4 illustrates the relation between a body surface model and Bezier control points;

FIG. 5 is a block diagram of an exemplar computer system for implementing the method according to the invention,

FIG. 6 illustrates a reference body surface model and two exemplary transformations of said reference body surface model,

FIG. 7 shows a flow chart of a third example of a process according to the invention,

FIG. 8a shows an example of boundaries on an MRI image of a heart, and

FIG. 8b shows an example of contour lines forming a boundary of the heart.

### DETAILED DESCRIPTION OF EXEMPLARY EMBODIMENTS

Before describing the invention in more detail a definition of terms will be given:

inverse computation: any technique to estimate electrical properties of an internal organ such as the heart or brain from surface recordings using volume conduction models;

mesh: any set of points and their connections used to describe either a surface or a volume in 3D;

imaging modality: a technique to measure internal structure like MRI, CT or echo;

structural element: part of a patient or associated part of reference model in patient coordinates and/or abstract space coordinates. The largest structural element corresponds to the physical structure, i.e. entire body. A structural element can be subdivided in smaller structural elements (e.g. rectangular blocks);

transformation: (possibly non-linear) mapping of relative coordinates to patient coordinates or deformation of image defined in a coordinate system;

patient coordinates: coordinate system that was used to define points in real world space using the imaging modality;

abstract coordinates: conveniently chosen coordinate system that is common to all models and patients;

relative coordinates: local coordinate system within structural element;

X space: the space defined in X coordinates. Patient space is the physical space that can be described in patient coordinates.

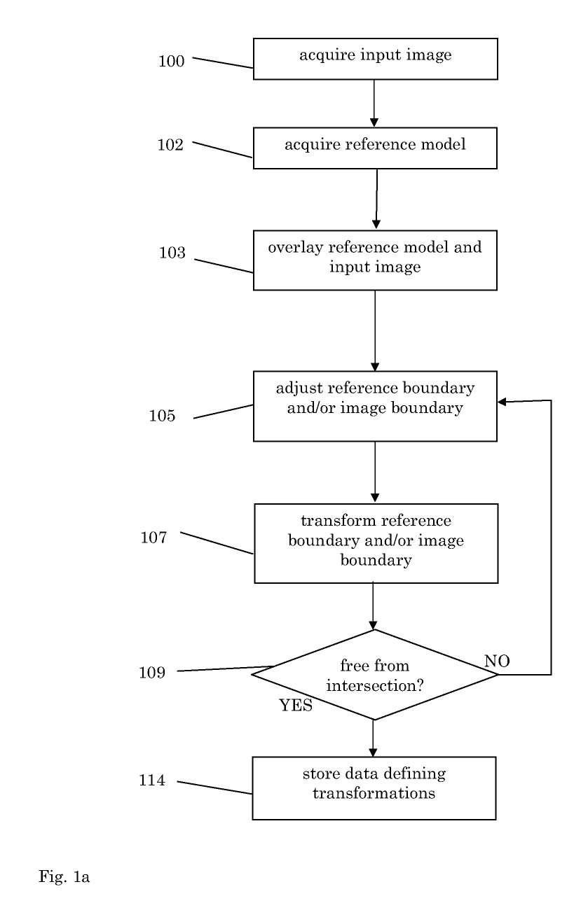

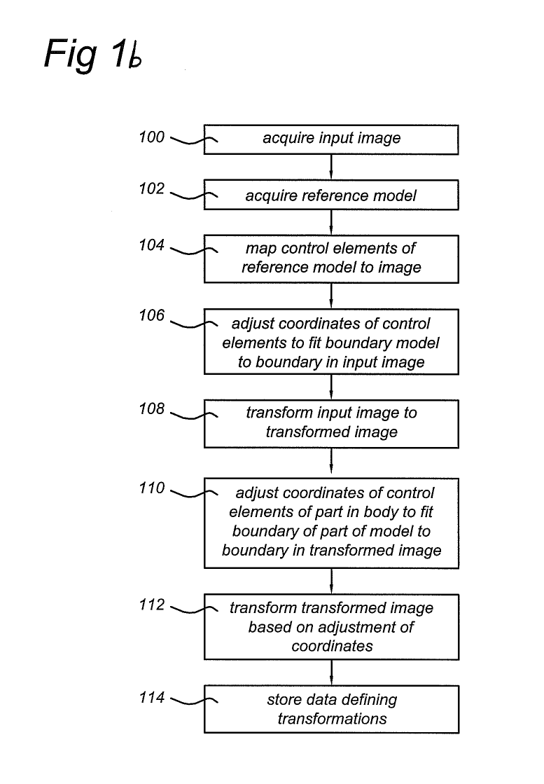

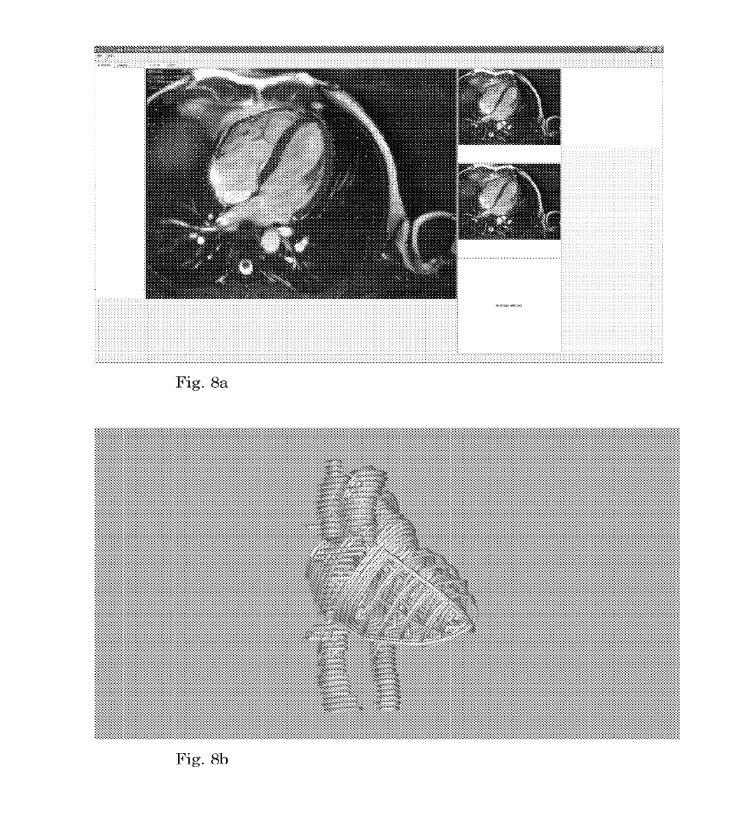

FIG. 1a shows a flow chart of a basic process according to the invention to match an anatomical image to a reference model having a reference model coordinate system. The process starts with action 100, acquiring an input image and action 102, acquiring a reference model. The input image can be any data captured by an imaging modality and suitable to visualize in two or more dimensions at least a part of a cross section of an organism, i.e. an animal, plant or human being. The image can be an MRI-scan data, CT-scan data, echo scan or any other sensed data suitable to visualize a cross section or part of an organism. An image according to the present invention can be a 2½D-image (=stack of 2D (two-dimensional) slices) or a 3D-image (three-dimensional image) wherein each pixel represents a volume (=voxel). The image comprises associated data to determine real-world dimensions within the organism. In the following description, the torso of a human being is used as an example of a cross section or part of an organism. The invention can be used to model any part of a body which can be defined by layers of structural elements wherein a structural element representing a part of the organism comprises smaller structural elements, which in turn could comprise even smaller structural elements, and so on. In this example a largest structural element is formed by the torso or body itself. This torso or body is defined by an image boundary that can for instance be discerned in an MRI or CT input image. In this example a smaller structural element is formed by a structure within the body, for instance a group of organs such as the lungs and heart combined. This structure is defined by an image boundary that can for instance be discerned in an MRI or CT input image. In this example a progressively smaller structural element may be formed by a part of the body such as an individual organ, e.g. the heart. This part is defined by an image boundary that can for instance be discerned in an MRI or CT input image. It will be appreciated that the structure may comprise a plurality of parts. An even smaller structural element may be formed by a portion of a part of the body, such as a ventricular blood volume, etc. FIG. 8a shows an example of boundaries on an MRI image of a heart. FIG. 8b shows an example of contour lines forming a boundary of the heart.

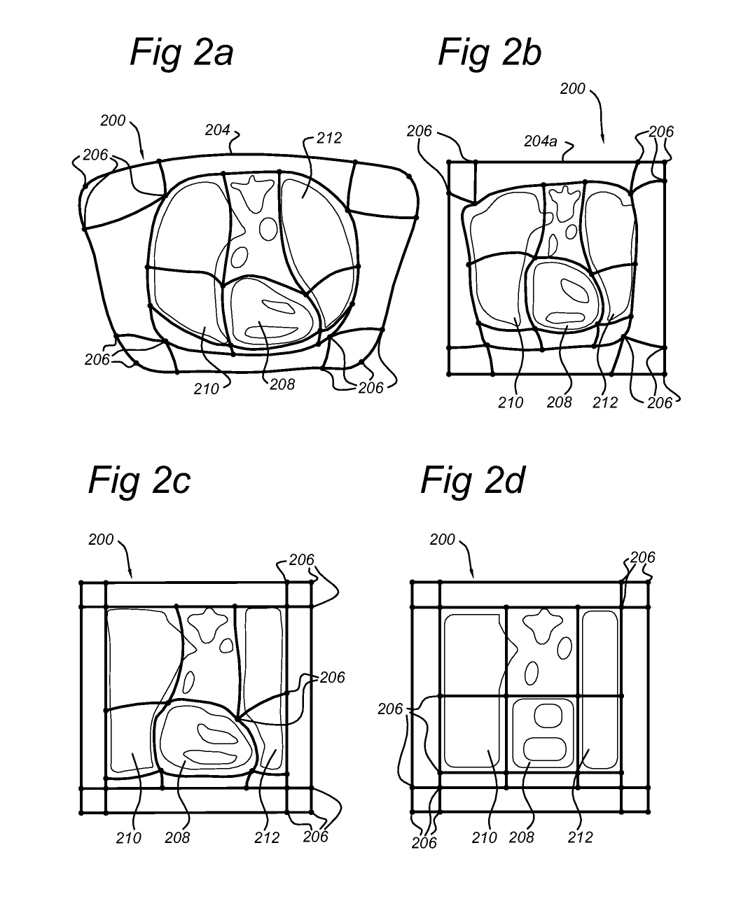

The reference model is an abstract description of a part of a living being, for example the upper part of a torso. In this example, the abstract space defined by the reference model is divided at a number of levels of details, preferably with cutting planes or lines along the major axes to divide the abstract space. In the abstract space every structural element may be described by a reference boundary. Also the reference model may include a reference boundary associated with the body, a reference boundary associated with a structure and a reference boundary associated with a part of the body, as described with respect to the input image. Preferably, in abstract space every model of a structural element can be approximated by a cubical or cuboid which is defined by the cutting planes. For example, the upper part of a torso is in a reference model represented by a cubical. In the cubical of the torso is a smaller cubical which represents volume inside the rib cage. The space in the reference model between the cubical of the torso and the cubical of the volume inside the rib cage represents the ribs, muscles and fatty tissue amassed under the hide. The cubical of the volume inside the rib cage is divided into cuboids representing the lungs, which could be a stack of four cubicles or cubes each, a cubical representing the space of the heart, a cubical below the heart representing the space of the tissue below the heart and a cubical above the heart representing the space of the tissue above the heart between the lungs. The cubical representing the heart could be subdivided into a cubical representing the volume of the left ventricle and a cubical representing the volume of the right ventricle. FIG. 2d shows an example of a reference model described above.

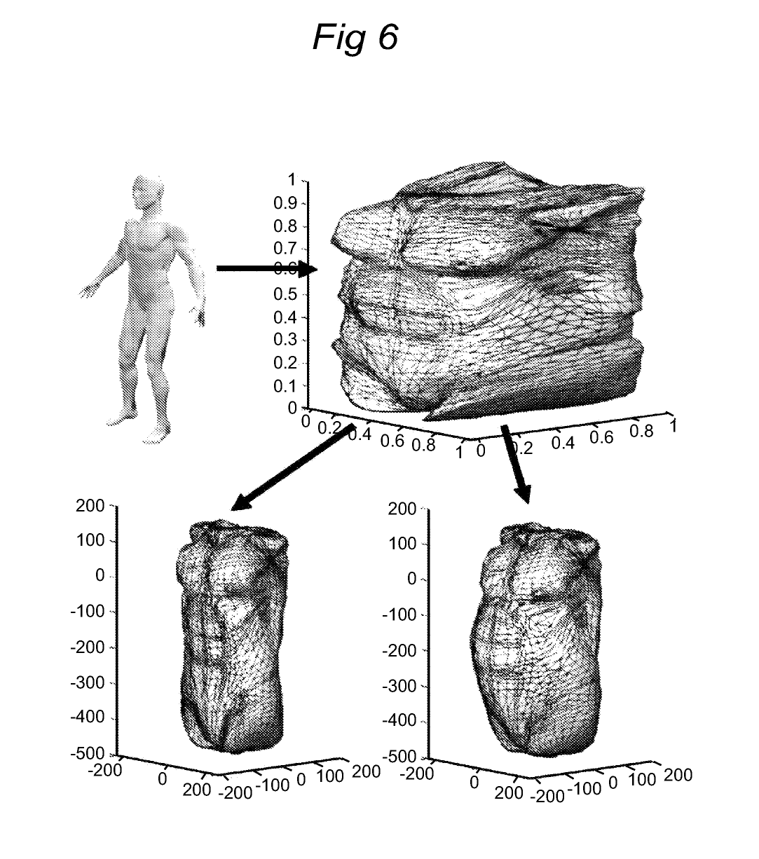

Every cubical representing a structural element of the reference model could comprise one or more associated model descriptions. For example, the cubical of the torso has one or more surface models of the torso, wherein each model could have a different mesh and triangulation. However, each model is defined in the same reference coordinate system. FIG. 6 shows a surface of the torso that fits into a cubical. The cubical representing the heart could comprise an associated 300-vertex triangulation of the heart, a 2400-vertex description of the heart, or any other suitable surface or volume description (i.e. triangular and quadrangular meshes, tetrahedrons, hexahedrons etc), a model of the fiber orientation, a model of the fiber orientation changes inside a deformed ventricle wall, a mechanical model of the heart, etc. A requirement is that all the associated models use the same reference model coordinate system to address positions in the abstract model space. Furthermore, corresponding points (e.g. the apex of the left ventricle or the midpoint of the tricuspid valve) in each associated model will have the same coordinates in the reference model coordinate system.

In action 103 the input image and the reference model are overlaid. In action 105 at least a portion of one of the reference boundaries is adjusted such that this reference boundary and the associated image boundary substantially coincide. It will be appreciated that it is also possible that at least a portion of one of the image boundaries is adjusted such that this image boundary and the associated reference boundary substantially coincide. It will be appreciated that it is also possible that both the image boundary and reference boundary are adjusted so as to substantially coincide.

In action 107 a portion of the reference model is transformed according to the adjustment of the adjusted reference boundary. It will be appreciated that it is also possible that the input image is transformed according to the adjusted image boundary. It will be appreciated that it is also possible that both the reference model and the input image are transformed.

In action 109 is checked whether or not the adjusted reference boundary intersects with the remaining reference boundaries. It will be appreciated that it is also possible that is checked whether or not the adjusted image boundary intersects with the remaining image boundaries. It will be appreciated that it is also possible that both the adjusted reference boundary and adjusted image boundary are checked.

If the check determines that no intersection is present, in action 114 data defining the transformation may be stored, e.g. as described in more detail below. If the check determines that intersection is present, the relevant boundary may be re-adjusted in order to remove the intersection.

It will be appreciated that the resulting transformed reference model will conform to the input image, while boundaries in the transformed reference model, e.g. of the body, of the structure or of one or more of the parts of the body do not intersect. Alternatively, the resulting transformed input image will conform to the reference image, while boundaries in the transformed input image, e.g. of the body, of the structure, or of one or more of the parts of the body do not intersect.

In the example of FIG. 1b each structural element of the reference model comprises control elements. A control point has a defined position in the reference model and represents a characteristic of the corresponding part of the body, for example the outline of the structural element, a specific point, for example the apex of the left ventricle, of the structural element which could be identified in an image. The control elements are used to define a relation between coordinates of an image, which is captured by an imaging modality, and the reference model, and to specify the transformation to transform/deform the image from one coordinate system to another coordinate system. In action 104, the control elements and boundary of the largest structural element of the reference model are mapped on the input image. This can be done by hand or automatically. Furthermore in action 104 coordinates in the image reference system are assigned to the control elements. At this stage, the control elements defines the relation of said positions in the image space and the reference model space. In an embodiment, firstly the image is adapted to have coordinates in the same range as the reference model. This could be done by a linear transformation including translation, rotation and scaling. The performed adaptation which can be expressed in an equation defining the relation between a coordinate in the image and corresponding coordinate in the adapted image, is stored as associated transformation data to enable the back transformation from scaled image to original image and/or the calculation of image coordinates to real word coordinates. After scaling the same coordinates are used in the image and the reference model to identify a position in both the image and reference model. It should be noted that in stead of adapting the range of coordinates from the image to the range of coordinates in the reference model, the range of coordinates in the reference model can be adapted to fit the range of coordinates in the image.

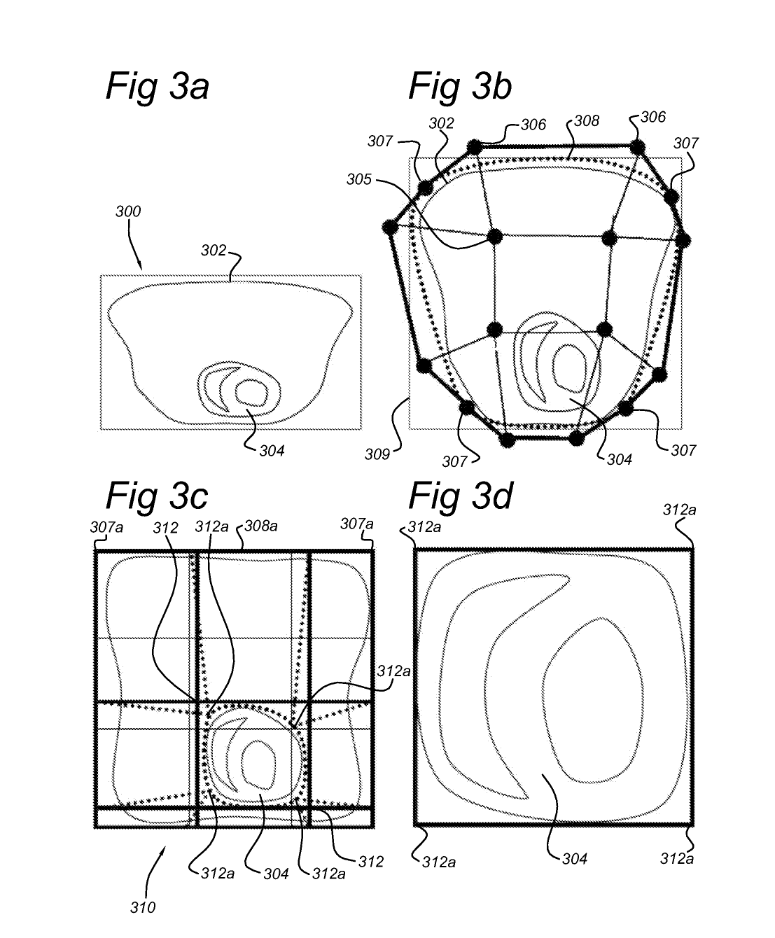

Then in action 106 the coordinates of the control elements are adjusted such that the boundary of the structural element fits the boundary of the corresponding structural element in the image. When the structural elements are cubicles in the reference model, the control elements can be Bezier control points. The Bezier control points define a line in 2D and a surface in 3D. FIG. 3b illustrates action 106. The dots 305, 306, and 307 of the mesh are the Bezier control points. After action 104, 12 Bezier control points are on the cubical 309. Four control points are on the angle points and eight control points are equidistantly distributed along the edges. FIG. 3b shows how the control points 307, 306 have to be adjusted to define a contour 308 which approximates the contour of the body in the image. The contour 308 is an adjusted boundary which is obtained by using the Bezier transformation. The control point 307 corresponds to the control points which position was on the angle point of the square 309.

In action 108, the image area within the boundary 308 is transformed to obtain an transformed image. Preferable the transformation uses tri-cubic interpolation commonly known to the skilled person in the art. The transformed image has coordinates in a transformed coordinate system which corresponds to reference model coordinate system. It should be noticed that the transformation projects the control points from adjusted coordinates to the original coordinates in the reference model coordinate system. Thus the image parts associated with the control elements are projected to the predefined coordinates in the reference model coordinate system. By this action the contour 308 is transformed into a cubical. FIG. 3c illustrates where the image parts corresponding to the control points 307 in FIG. 3b are projected in the transformed image. The coordinates of control points 307 are projected to a position in the transformed image corresponding to reference numeral 307a respectively.

FIG. 2a illustrates how the control elements 206 of a reference model are mapped on an image showing a body 200. In this example the control elements correspond to the angular points of the cubicles of the structural elements of the reference model and the lines between control points correspond to the ribs forming the cubicles. The figure shows further the right lung 210, the heart 208 and the left lung 212. FIG. 2b illustrates the result after performing the action 104, 106 and 108. The body 200 is now fit into a squared image. The contour 204 of the body is now on the edge of the image 204a. The control points 206 having a position in the body have a position in the squared image. The transformation performed should be a unique transformation wherein every point in the original image shown in FIG. 2a has only one corresponding point in the transformed image shown in FIG. 2b. In an embodiment a cubic Bezier type interpolation, known to the person skilled in the art, is used to transform the image of FIG. 2a in to the image shown in FIG. 2b.

FIGS. 3a, 3b and 3c illustrate another example of performing the actions 104, 106 and 108. FIG. 3a shows the contour 302 of a body 300 and a heart 304 in the body. FIG. 3b shows the image after performing action 104. Overlaid are the control elements which corresponds in this example to the 16 Bezier control points 305, 306, and 307 after performing action 106. Prior to performing action 106, the control point 307 where on the angle points of the image and the control points 306 at the edge of the image. By adjusting the coordinates of the control elements 306, 307, the contour 308 defined by the control elements changes. Control elements 305 can either be automatically interpolated or adjusted by hand. The position of the control elements is adjusted such that the contour 308 approximates the contour of the body 302.

Then action 108 is performed, wherein the image part within the contour 308 is transformed into a squared image. The edge of the image 308a of the image in FIG. 3c corresponds the contour 308 in FIG. 3b. It can be seen that the control elements 307 on the contour 308 in FIG. 3b are now positioned at the angle points of FIG. 3c. It can further be seen that the contour of the body in FIG. 3c is now also more brick shaped. Also the heart, which is a structural element in the body, has been more cubical which provides a good starting point for performing the action 110.

In action 110, the control elements of the largest structural element in the reference model are adjusted such that the boundary of said structural element fits or approximates the boundary of the image area for which the structural element is representative. In the example shown in FIGS. 2a-2d, the largest structural element in the reference model represents the rib cage. FIG. 2b shows the position of control elements after performing action 110. It should be noted that after performing action 108, the coordinate system of the image corresponds to the coordinate system of the reference model. Therefore, as the coordinates of the control elements by action 108 are mapped on their original predefined coordinates in the reference model, the position of the control elements defining the rib cage defining the cubical in the reference model have the same position in the image when starting action 110, and would be represented as a cubic in the image when laid over the image.

Then in action 112, the image is transformed such that the pixels according to the control elements having the adjusted coordinates are positioned on the original predefined coordinates of the control elements in the reference model. Action 108 makes use of the same transformation algorithm as action 108.

FIG. 2c illustrates the resulting image after action 108. It can be seen that the lungs 210, 212 have become a more cubical shape. It can further be seen that the structural element corresponding to the rib cage comprises a sub structural element, namely the heart 208. In the reference model, the heart 208 has a corresponding cubical. Action 110 and 112 could be repeated for the structural elements in the rib cage, thus adjusting the control elements of a smaller structural elements within a current structural element and transforming the image part corresponding to the current structural element based on the adjusted coordinates of the control elements.

FIG. 3c illustrates the principle of action 110 and 112. The black solid lines in the image represents the predefined position of the edges of the respective structural elements in the reference model when overlaid over an image have the same coordinate reference system. Then by action 110, the coordinates of control elements 312 having the predefined position are adjusted such that the contour defined by the control elements approximates the contour of the heart 304. References 312a indicates the position after adjustment. The dotted line around the heart illustrates the overlaid contour defined by the control elements 312a. Then by action 112, the areas within the dotted lines, representing the edges between structural elements but with adjusted control elements 312a coordinated are adjusted such the image part at the position of the adjusted control element is projected on the predefined position of the control element in the reference model. Consequently, the image parts defined by the dotted lines are transformed to fit in the rectangles areas defined by the black solid lines. FIG. 3d illustrates the image area of the heart after performing the action 112. It can be seen that the shape of heart 304 in the image approximates a cubical.

In action 114, data defining the preformed transformations on the structural elements is stored as associated data. The associated data enables a computer program to reconstruct the original image corresponding to a structural element from the transformed image. The number of transformations needed to reconstruct the original image part of a structural element depends on the number of larger structural elements said structural element is in. For example, the structural element heart is in the structural element rib cage, which is in structural element body. Therefore, to reconstruct the original image of the heart in image 2d, transformation data related to the transformation of the structural elements in the rib cage is needed, the transformation data related to the transformation of the rib cage in the body is needed and the transformation of the body to patient coordinates is needed. The associated data corresponds to the data needed to reconstruct FIG. 2c from 2d, to reconstruct FIG. 2c from 2b and reconstruct FIG. 2a from FIG. 2b.

The above described method is easy and intuitive to use. The method provides data which makes it possible to find a point in patient space, defined by the input image, from a point in the abstract space defined by the reference model and vice versa. Furthermore, the model allows to define different levels of detail. It is further possible to project people having different body size and having internally different relative position and shapes of organs and even the internal structures of the organs on the same reference model.

Every structural element contains information where the control elements of points are within the relative coordinate system of the containing level as well as the positions of the control points within its own relative coordinate system. In stead of the position in relative space of the next level up, the top level will contain the positions of its control points in patient space.

To find a point in patient space from a point in abstract space all hierarchical structural elements that contain the point are found. Starting at the top level the positions in patient space of the control points of the next lower level are computed. Having the control points in patient space the transformations in this structural element can now be applied to find the coordinates in patient space of the control points in the level below that were defined in relative coordinates with respect to this element. With every step the control points get closer to the point and the organ it is in gets better defined.

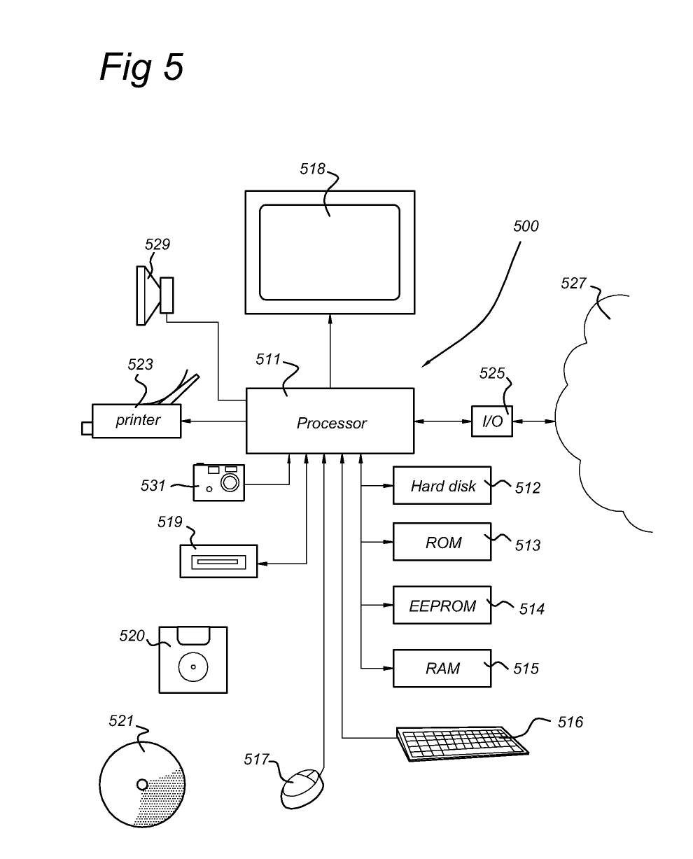

In FIG. 5, an overview is given of a computer arrangement 500 suitable for implementing the present invention. The computer arrangement 500 comprises a processor 511 for carrying out arithmetic operations. The processor 511 is connected to a plurality of memory components, including a hard disk 512, Read Only Memory (ROM) 513, Electrical Erasable Programmable Read Only Memory (EEPROM) 514, and Random Access Memory (RAM) 515. The memory components comprises a computer program comprising data, i.e. instructions arranged to allow the processor 511 to perform the method for generating a spatial-data-change message or the method for processing a spatial-data-change message according to the invention. Not all of these memory types need necessarily be provided. Moreover, these memory components need not be located physically close to the processor 511 but may be located remote from the processor 511. The digital reference model database associated with the methods may or may not be stored as part of the computer arrangement 500. For example, the digital reference model database may be accessed via web services.

The processor 511 is also connected to means for inputting instructions, data etc. by a user, like a keyboard 516, and a mouse 517. Other input means, such as a touch screen, a track ball and/or a voice converter, known to persons skilled in the art may be provided too.

A reading unit 519 connected to the processor 511 may be provided. The reading unit 519 is arranged to read data from and possibly write data on a removable data carrier or removable storage medium, like a floppy disk 520 or a CDROM 521. Other removable data carriers may be tapes, DVD, CD-R, DVD-R, memory sticks, solid state memory (SD cards, USB sticks) compact flash cards, HD DVD, blue ray, etc. as is known to persons skilled in the art.

The processor 511 may be connected to a printer 523 for printing output data on paper, as well as to a display 518, for instance, a monitor or LCD (liquid Crystal Display) screen, head up display (projected to front window), or any other type of display known to persons skilled in the art.

The processor 511 may be connected to a loudspeaker 529 and/or to a capturing device 531 for obtaining image data, such as a MRI-scanning device, CT-scanning device, Ultrasound scanning device (echo), digital camera/web cam or a scanner, arranged for scanning graphical and other documents.

Furthermore, the processor 511 may be connected to a communication network 527, for instance, the Public Switched Telephone Network (PSTN), a Local Area Network (LAN), a Wide Area Network (WAN), Wireless LAN (WLAN), GPRS, UMTS, the Internet etc. by means of I/O means 525. The processor 511 may be arranged to communicate with other communication arrangements through the network 527.

The data carrier 520, 521 may comprise a computer program product in the form of data and instructions arranged to provide the processor with the capacity to perform a method in accordance to the invention. However, such computer program product may, alternatively, be downloaded via the telecommunication network 527 into a memory component.

The processor 511 may be implemented as a stand alone system, or as a plurality of parallel operating processors each arranged to carry out subtasks of a larger computer program, or as one or more main processors with several sub-processors. Parts of the functionality of the invention may even be carried out by remote processors communicating with processor 511 through the telecommunication network 527.

The components contained in the computer system of FIG. 5 are those typically found in general purpose computer systems, and are intended to represent a broad category of such computer components that are well known in the art.

Thus, the computer system of FIG. 5 can be a portable device, a personal computer, a workstation, a minicomputer, a mainframe computer, etc. The computer can also include different bus configurations, networked platforms, multi-processor platforms, etc. Various operating systems can be used including UNIX, Solaris, Linux, Windows, Macintosh OS, and other suitable operating systems.

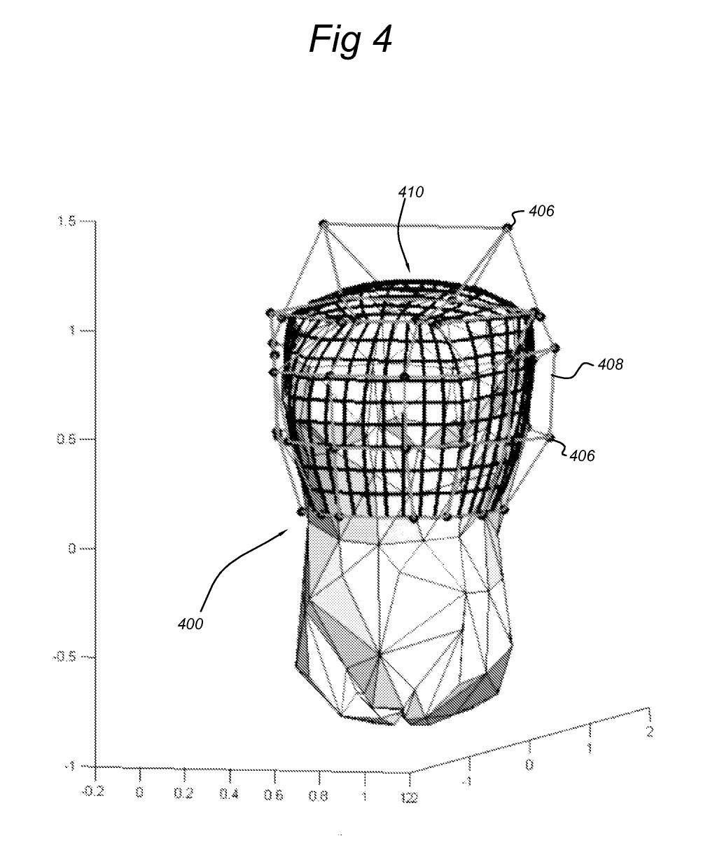

The solution presented here is based on the concept that corresponding points (e.g. the apex of the left ventricle or the midpoint of the tricuspid valve) in each subject will have the same generic abstract coordinates in a model reference space. The generic coordinates have values between 0 and 1 in all three dimensions. The space that defines these generic points is deformed in a continuous fashion using tri-cubic interpolation to match the patient. In one embodiment, we have chosen Bezier-style definition of the deformation. Cubic Bezier splines have 4 control points, in 2D, Bezier surfaces are described by 16 points, see FIG. 3b, and for 3D 64 control points are required, see FIG. 4. The method allows for the transformation from generic to image coordinates and vice versa, as long as the volume is not self-intersecting. To be able to independently adjust the shape of the various internal organs a hierarchical approach is chosen, see FIGS. 2 and 3. In this approach first the surface of the torso is matched, see FIGS. 2a and 3b, thereby getting the internal organs shown in the image in approximately the correct position in the reference model space. FIG. 2b shows the approximated positions in the reference model coordinate system and FIG. 2d shows the final positions in the reference model coordinate system. Then, using internal organs like the lungs and liver as a reference the position of the heart is defined, see FIG. 2b and FIG. 3c. Finally the details of the heart itself are adjusted. This is illustrated by FIGS. 2c and 2d.

To generate a patient-specific anatomical model requires a number of steps. First we select a cube in imaging coordinates that will fit around the torso. Bezier control points from another model are loaded to get a rough approximation of the torso boundaries. This cube is deformed using the 64 Bezier control points to fit the torso to the generic mesh. Bezier coordinates in general run from zero to one, so this procedure gives a unit cube where every point within corresponds to a unique point in imaging space inside the patient. This unit cube is now divided in smaller cubes, the largest one of these will be used to describe the volume inside the rib cage. This block has generic coordinates of, say, 0.1 to 0.9 along the x and y axis and 0.3 to 0.9 along the z axis. Using the Bezier control points of the entire torso it is possible to compute the imaging coordinates that correspond to the 64 control points that define this cube. The relative repositioning of these control points within the Bezier framework is known so we can now in the <0.1,0.1,0.3> to 0.9,0.9,0.9> range of generic coordinates compute the imaging points by using tri-cubic interpolation twice. For the heart itself there is a sub-cube within the ribcage block, so that adds another level of detail. The torso can be contained in a larger cube that contains the entire body, so there can actually be another level on top.

An interesting consequence of this technique is that the reference meshes for the heart, the lungs, and the torso all are approximately brick-shaped in the generic coordinates in a reference model coordinate system (see e.g. FIG. 2d).

To compute a point in the imaging coordinate system of the patient from the generic coordinates also takes a number of steps. First, for the top cube the normalized coordinates are matched to the imaging coordinates. Using the Bezier deformation the imaging coordinates of the 64 control points of its sub-cubes can be computed. This tree traversal is required only once for an individual patient. Computing an imaging point from a reference model coordinate is by finding the smallest cube that contains this coordinate and applying the Bezier transformations performed on the smallest cube and transformations performed on the larger cubes which encompass the smallest cube.

The proposed mapping algorithm facilitates adaptation of specific generic models for specific applications. Moreover, it greatly facilitates inter-subject comparisons of anatomy in a quantitative manner. The invention enables software engineers to write specific software to support the matching of this generic model to MRI and CT data.

Various meshes for the body surface, heart, and lungs have been converted to coordinates in a model reference system. Applying the individual transformations gives the individually matched surfaces. FIG. 6 shows in the top left an example of a male figure from Poser 5 (Curious Labs, http://e-frontier.com), although other models may be used. After exporting, the head and extremes were removed and the surface model of the Poser 5 torso was deformed to fit into the unit cube in generic coordinates of the reference model coordinate system (top right). A first individual-specific transformation definition was used to fit the model to the MRI data from a patient and the inverse transformation result of the surface model of the Poser 5 torso by means of the individual specific transformation definition is shown at the bottom left. Another individual specific transformation, corresponding to a somewhat more obese patient, was used to convert the surface model of the Poser 5 torso to the surface model in patient coordinate as shown at the bottom right side. Both specific transformation definitions could be obtained by the actions 100-108 described above.

Within this framework we can now compute activation times in a triangular mesh by e.g. an inverse calculation and put that timing in a mechanical model to find the order of contraction. We can even compare this to the actual movement that was measured by tagged MRI on a point by point basis.

The presented method can be performed automatically on image data. The method can be used in a semi-automatic or manual process. In an embodiment, the method comprises the automatic step to position the control points such that a first approximation of the boundary of one or more structural elements is given. The operator will examine the approximated boundaries of the one or more structural elements and correct if necessary the boundary by changing the position of the control points in the image. The operator could further verify whether selected reference models for different structural elements to be used in further analysis when transformed to patient space complies with natural constrains. For example surface triangulations for ECG analysis or the heart and lungs should not intersect in patient space.

It will be appreciated, that according to an aspect of the invention, the method can briefly be described as overlaying a larger structural element of reference model and the input image. Next steps in the method include adjusting the boundaries defining the larger structural element such that the boundaries in the reference model and input image substantially coincide and then transforming the area defined by the boundary to correspond to the same dimensions in the reference model space or input image, respectively. Then the same procedure is repeated for smaller structural elements of the reference model and the input image. Preferably, the smaller structural element is a portion of the larger structural element.

Thus it is possible to first transform the portion of the reference model and/or of the input image associated with the body, and next do the same for a structure, such as the heart and lungs combined, and next do the same for a part of the body such as the heart itself. It will be appreciated that such layered approach makes it relatively easy to ensure that, in the reference model and/or in the input image, points that are immediately on either side of a boundary are also immediately on either side of the adjusted boundary in the transformed model and/or the transformed image. Thus, it is relatively easy to prevent that boundaries (e.g. of two parts, of a part and a structure, of a structure and the body, or of a part and the body) intersect. Thus, a derived model, such as a volume electrical conduction model, may be prevented from failing due to the presence of multiple conduction values at a single location.

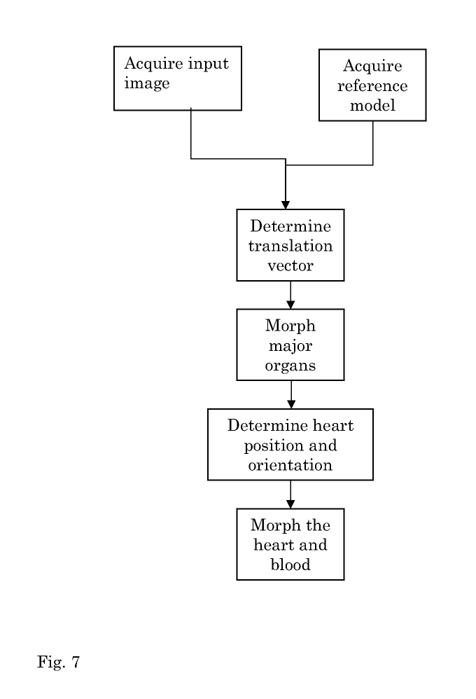

FIG. 7 shows a flow chart of a further example of a method according to the invention. First, an input image and a reference model are acquired.

In this example, the reference model is formed by a volume conductor model containing several meshed structural elements, e.g. heart, blood volumes, lungs, liver and the thorax, each having a reference boundary. In this example in the input image tissue transitions are determined, resulting in image boundaries, e.g. as shown in FIGS. 8a and 8b.

Next, a translation vector is determined such that the reference model matches the image boundaries on the clinical input images (e.g. MRI) best. In this example, initially the surrounding outer geometry of the thorax, i.e. the boundary of the body, is used to estimate the translation vector. In one embodiment, a measure of optimal match can be determined by virtually connecting strings between all contour points and the nearest point on the meshed thorax. The minimal tension in all strings is then the measure for the optimal position. It is possible that a contour point of the reference boundary is connected to only one nearest points on the associated image boundary. It is also possible that a contour point of the reference boundary is connected to a plurality of nearest points on the associated image boundary. It is also possible that a plurality of contour point of the reference boundary is connected to a single nearest point on the associated image boundary. In the latter two cases the tension on the strings may e.g. be averaged. It will be appreciated that other methods of determining the translation vector may be used such as a least squares method.

Assuming an optimal position for all structural elements, in this example the reference boundaries associated with the thorax, lungs and liver are transformed (sometimes referred to as morphed), e.g. blown up or inflated locally, such that these reference boundaries match the image boundaries drawn on the input image. The morphed structural elements (thorax, lungs and liver) are now frozen. These frozen structural elements leave a limited space for the reference boundary associated with heart. The heart may be both different in orientation (in young people the heart is nearly vertical, for people above 40 the heart is rotated approximately 30-40 degrees) and position (higher/lower) between individuals. Thus an optimization/search algorithm is used to determine the optimum shift and rotation of the reference boundary of the heart and the blood volumes therein such that they do intersect the reference boundaries of the lungs and liver minimal. Herein the reference boundary of the heart is to match the image boundary of the heart. If an optimal position and/or orientation has been found for the reference boundary of the heart, first the epicardial wall (the outside boundary of the heart) is pulled towards the respective image boundary keeping the wall thickness of the epicardium as constant as possible. Next the endocardial wall, and accordingly the reference boundary associated with blood cavities within the heart, are matched with the respective image boundaries. During morphing the consistency of the structural elements may be checked in every step.

It should be noted that the methods described above assume that a reference model is available, which comprises as a structural element one or more associated reference meshes describing the boundary of a part of a body. The invention is also very useful to develop such meshes. Image processing algorithms can be used to determine the boundary of said parts in the images. Subsequently, the boundary is transformed to the reference model coordinate system. Having the boundary of several patients in the reference model coordinate system, an average boundary can be generated and a corresponding mesh with triangulation can be generated and linked to the reference model in the reference model database. An advantage of the present invention is that it is now possible to start medical analysis based on rough or old models and that it will be possible to perform the same medical analysis but then on more accurate or new models. It is also possible to perform statistical or sensitivity analysis on variations in a reference model on the analysis results.

It will be appreciated that within the methods of the invention it is possible to transform reference boundaries to match associated image boundaries, to transform image boundaries to match associated reference boundaries, or to transform both reference boundaries and image boundaries.

The foregoing detailed description of the invention has been presented for purposes of illustration and description. It is not intended to be exhaustive or to limit the invention to the precise form disclosed, and obviously many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. Method of linking coordinates of an image to coordinates of a reference model, the method comprising the steps:
acquiring a 2½D or 3D input image representing a body of a living being and including at least two image boundaries of at least two parts within said body in an image reference system, coordinates in the image having a relationship with a real world reference system;
a) acquiring a 3D reference model representative of a reference living being describing in a reference model coordinate system at least two reference boundaries of the at least two parts within said body;
b) overlaying the reference model and the input image;
c) adjusting at least a portion of one of the reference boundaries and/or at least one of the image boundaries such that this reference boundary and this image boundary substantially coincide, while the adjusted reference boundary does not intersect with the remaining reference boundaries and/or the adjusted image boundary does not intersect with the remaining image boundaries.

2. Method according to claim 1, further including transforming a portion of the reference model and/or a portion of the input image according to the adjustment of the adjusted reference boundary and/or according to the adjustment of the adjusted image boundary.

3. Method according to claim 1, wherein the step d) includes:
checking whether the adjusted reference boundary intersects with the remaining reference boundaries and/or the adjusted image boundary intersects with the remaining image boundaries; and
if an intersection is detected re-adjusting said adjusted reference boundary and/or said adjusted image boundary until no intersection is detected.

4. Method according to claim 3, wherein said re-adjusting includes reducing a translation and/or rotation of said adjusted reference boundary and/or said adjusted image boundary.

5. Method according to claim 3, wherein said re-adjusting includes adjusting a larger portion of said adjusted reference boundary and/or said adjusted image boundary.

6. Method according to claim 1 wherein
the input image further represents an image boundary of the body of the living being;
the reference model further describes a reference boundary of the body of the reference living being;
wherein the method includes prior to step d):
e) overlaying the reference boundary of the body and the image boundary of the body;
f) adjusting at least a portion of the reference boundary of the body and/or the image boundary of the body such that this reference boundary and this image boundary substantially coincide;
g) transforming a portion of the reference model and/or a portion of the input image according to the adjustment of the adjusted reference boundary of the body and/or according to the adjustment of the adjusted image boundary of the body.

7. Method according to claim 1 wherein
the input image further represents an image boundary of a structure of the living being, said structure including the at least two parts;
the reference model further describes a reference boundary of a structure of the reference living being, said structure including the at least two parts;
wherein the method includes prior to step d):
h) overlaying the reference boundary of the structure and the image boundary of the structure;
i) adjusting at least a portion of the reference boundary of the structure and/or the image boundary of the structure such that this reference boundary and this image boundary substantially coincide;
j) transforming a portion of the reference model associated with the reference boundary of the structure and/or a portion of the input image associated with the image boundary of the structure according to the adjustment of the adjusted reference image boundary of the structure and/or the adjusted image boundary of the structure.

8. Method according to claim 6, wherein
the reference model comprises a first structural element representative of the boundary of the body and at least two second structural elements representative of the boundaries of the at least two parts;
the first and second structural elements have control elements associated therewith, the control elements having predefined coordinates in the reference model coordinate system and defining the boundary of the associated structural element in the reference model coordinate system;
the step of overlaying e) includes overlaying the control elements and the corresponding reference boundary of the structural element representative of the body on the input image, and assigning coordinates in the image reference system to the control elements;
the step f) includes adjusting of the coordinates of the control elements associated with said structural element in the image reference system;
the step g) includes a transformation to transform the image area corresponding to the adjusted overlaid reference boundary to obtain a transformed image, the transformed image having coordinates in a transformed image coordinate system, wherein the transformed image coordinate system corresponds to the reference model coordinate system and the image portions associated with the coordinates of the overlaid reference boundary being projected to the predefined coordinates of the corresponding boundary of the structural element in the reference model coordinate system; and wherein
step d) includes adjusting an overlaid reference boundary of the structural elements of at least one part of the reference model over the transformed image to approximate the image boundary of that part within the body in the transformed image by adjusting coordinates of control elements associated with the structural element representative of that part in the reference model in the transformed image coordinate system; the method further including
a transformation wherein image portions associated with coordinates of the adjusted overlaid reference boundary of said part are projected in the transformed image to the predetermined coordinates of the corresponding boundary of the structural element representative of the boundary of said part in the reference model coordinate system.

9. Method according to claim 6, wherein
the reference model comprises a first structural element representative of the boundary of the body and at least two second structural elements representative of the boundaries of the at least two parts;
the first and second structural elements have control elements associated therewith, the control elements having predefined coordinates in the image reference system and defining the boundary of the associated structural element in the image reference system;
the step of overlaying e) includes overlaying the control elements and the corresponding reference boundary of the structural element representative of the body on the input image, and assigning coordinates in the reference model coordinate system to the control elements;
the step f) includes adjusting of the coordinates of the control elements associated with said structural element in the reference model coordinate system;
the step g) includes a transformation to transform the model area corresponding to the adjusted overlaid reference boundary to obtain a transformed model, the transformed model having coordinates in a transformed model coordinate system, wherein the transformed model coordinate system corresponds to the image reference system and the model portions associated with the coordinates of the overlaid reference boundary being projected to the predefined coordinates of the corresponding boundary of the structural element in the image reference system; and wherein
the step d) includes adjusting an overlaid reference boundary of the structural elements of at least one part of the transformed model over the input image to approximate the image boundary of that part within the body in the transformed model by adjusting coordinates of control elements associated with the structural element representative of that part in the reference model in the transformed model coordinate system; the method further including
a transformation wherein model portions associated with coordinates of the adjusted overlaid reference boundary of said part are projected in the transformed model to the predetermined coordinates of the corresponding boundary of the structural element representative of the boundary of said part in the image reference system.

10. Method according to claim 7, wherein
the reference model comprises a third structural element representative of the boundary of the structure and at least two second structural elements representative of the boundaries of the at least two parts;
the third and second structural elements have control elements associated therewith, the control elements having predefined coordinates in the reference model coordinate system and defining the boundary of the associated structural element in the reference model coordinate system;
the step of overlaying e) includes overlaying the control elements and the corresponding reference boundary of the structural element representative of the structure on the input image, and assigning coordinates in the image reference system to the control elements;
the step f) includes adjusting of the coordinates of the control elements associated with said structural element in the image reference system;
the step g) includes a transformation to transform the image area corresponding to the adjusted overlaid reference boundary to obtain a transformed image, the transformed image having coordinates in a transformed image coordinate system, wherein the transformed image coordinate system corresponds to the reference model coordinate system and the image portions associated with the coordinates of the overlaid reference boundary being projected to the predefined coordinates of the corresponding boundary of the structural element in the reference model coordinate system; and wherein
the step d) includes adjusting an overlaid reference boundary of the structural elements of at least one part of the reference model over the transformed image to approximate the image boundary of that part within the body in the transformed image by adjusting coordinates of control elements associated with the structural element representative of that part in the reference model in the transformed image coordinate system; the method further including
a transformation wherein image portions associated with coordinates of the adjusted overlaid reference boundary of said part are projected in the transformed image to the predetermined coordinates of the corresponding boundary of the structural element representative of the boundary of said part in the reference model coordinate system.

11. Method according to claim 7, wherein
the reference model comprises a third structural element representative of the boundary of the structure and at least two second structural elements representative of the boundaries of the at least two parts;
the third and second structural elements have control elements associated therewith, the control elements having predefined coordinates in the image reference system and defining the boundary of the associated structural element in the image reference system;
the step of overlaying e) includes overlaying the control elements and the corresponding reference boundary of the structural element representative of the structure on the input image, and assigning coordinates in the reference model coordinate system to the control elements;
the step f) includes adjusting of the coordinates of the control elements associated with said structural element in the reference model coordinate system;
the step g) includes a transformation to transform the model area corresponding to the adjusted overlaid reference boundary to obtain a transformed model, the transformed model having coordinates in a transformed model coordinate system, wherein the transformed model coordinate system corresponds to the image reference system and the model portions associated with the coordinates of the overlaid reference boundary being projected to the predefined coordinates of the corresponding boundary of the structural element in the image reference system; and wherein
the step d) includes adjusting an overlaid reference boundary of the structural elements of at least one part of the transformed model over the input image to approximate the image boundary of that part within the body in the transformed model by adjusting coordinates of control elements associated with the structural element representative of that part in the reference model in the transformed model coordinate system; the method further including
a transformation wherein model portions associated with coordinates of the adjusted overlaid reference boundary of said part are projected in the transformed model to the predetermined coordinates of the corresponding boundary of the structural element representative of the boundary of said part in the image reference system.

12. Method according to claim 1, wherein the step of adjusting includes
determining a translation vector required to pre-match the reference boundary and the associated image boundary, and then
determine a transformation, such as a, e.g. local, scale factor and/or rotation to match the reference boundary and the associated image boundary.

13. Method according to claim 12, wherein the translation vector is determined by determining virtual connecting strings between, e.g. all, contour points of the reference boundary and nearest points on the associated image boundary, and minimizing tension on the strings.

14. Method of linking coordinates of an image to coordinates of a reference model, the method comprising the steps:
a) acquiring a 2½D or 3D input image representing at least a portion of a body of a living being and including at least one image structure boundary of at least one structure within said body, and at least one image part boundary of at least one parts within said structure in an image reference system, coordinates in the input image having a relationship with a real world reference system;
b) acquiring a 3D reference model representative of a reference living being describing in a reference model coordinate system at least one reference structure boundary of at least one structure of the reference living being and at least one reference part boundary of the at least one part within said structure;
c) overlaying the reference model and the input image;
d) adjusting at least a portion of the reference structure boundary and/or the image structure boundary such that this reference structure boundary and this image structure boundary substantially coincide;
e) transforming a portion of the reference model associated with the reference structure boundary and/or a portion of the input image associated with the image structure boundary according to the adjustment of the reference structure boundary and/or the image structure boundary, and then
f) adjusting at least a portion of the reference part boundary and/or the image part boundary such that this reference part boundary and this image part boundary substantially coincide; and
g) transforming a portion of the reference model associated with the reference part boundary and/or a portion of the input image associated with the image part boundary according to the adjustment of the reference part boundary and/or the image part boundary.

15. Method of linking coordinates of an image to coordinates of a reference model, the method comprising the steps:
a) acquiring a 2½D or 3D input image representing at least a portion of a body of a living being and including an image body boundary of the body, at least one image structure boundary of at least one structure within said body, and at least one image part boundary of at least one parts within said structure in an image reference system, coordinates in the input image having a relationship with a real world reference system;
b) acquiring a 3D reference model representative of a reference living being describing in a reference model coordinate system a reference body boundary of the body, at least one reference structure boundary of at least one structure of the reference living being and at least one reference part boundary of the at least one part within said structure;
c) overlaying the reference model and the input image;
d) adjusting at least a portion of the reference body boundary and/or the image body boundary such that this reference body boundary and this image body boundary substantially coincide;
e) transforming a portion of the reference model associated with the reference body boundary and/or a portion of the input image associated with the image body boundary according to the adjustment of the reference body boundary and/or the image body boundary; and then
f) adjusting at least a portion of the reference structure boundary and/or the image structure boundary such that this reference structure boundary and this image structure boundary substantially coincide;
g) transforming a portion of the reference model associated with the reference structure boundary and/or a portion of the input image associated with the image structure boundary according to the adjustment of the reference structure boundary and/or the image structure boundary, and then
h) adjusting at least a portion of the reference part boundary and/or the image part boundary such that this reference part boundary and this image part boundary substantially coincide; and
i) transforming a portion of the reference model associated with the reference part boundary and/or a portion of the input image associated with the image part boundary according to the adjustment of the reference part boundary and/or the image part boundary.

16. Method of linking coordinates of an image to coordinates of a reference model, the method comprising the steps:
a) acquiring a 2½D or 3D input image including a first image boundary of a body of a living being and at least two second image boundaries of at least two parts within said body in an image reference system, coordinates in the input image having a relationship with a real world reference system;
b) acquiring a 3D reference model representative of a reference living being describing in a reference model coordinate system a first reference boundary of the body of the reference living being and at least two second reference boundaries of the at least two parts within said body, wherein the reference model comprises a first structural element representative of the first reference boundary of the body and at least two second structural elements representative of the second reference boundaries of the at least two parts;
c) overlaying the reference model and the input image;
d) adjusting at least a portion of the first reference boundary of the body and/or the first image boundary of the body such that this first reference boundary and this first image boundary substantially coincide;
e) transforming a portion of the reference model associated with the first reference boundary of the body and/or a portion of the input image associated with the first image boundary of the body according to the adjustment of the first reference boundary of the body and/or the first adjusted image boundary of the body, and then
f) adjusting at least a portion of one of the second reference boundaries and/or at least one of the second image boundaries such that this second reference boundary and this second image boundary substantially coincide; and
g) transforming a portion of the reference model associated with the second reference boundary and/or a portion of the input image associated with the adjusted second image boundary according to the adjustment of the second reference boundary and/or the second image boundary.

17. Method of linking coordinates of an image to coordinates of a reference model, the method comprising the steps:
a) acquiring a 2½D or 3D input image representing at least a portion of a body of a living being and including a first boundary of a first structural element of the body in an image reference system, coordinates in the image having a relationship with a real world reference system;
b) acquiring a 3D reference model representative of a reference living being describing in a reference model coordinate system a second boundary of a second structural element of the reference living being,
the first and/or second structural elements having control elements associated therewith, the control elements having predefined coordinates in the image reference system and/or the reference model coordinate system, respectively, and defining the boundary of the associated structural element in the image reference system and/or reference model coordinate system, respectively;
c) overlaying the reference model and the input image;
d) transforming a portion of the input image associated with the first boundary and a portion of the reference model associated with the second boundary to a common coordinate system;
e) adjusting of the control elements such that the first and second boundaries substantially coincide; and
f) transforming the image area corresponding to the adjusted first boundary to obtain a transformed image, the transformed image having coordinates in the common coordinate system, and/or transforming the reference model area corresponding to the adjusted second boundary to obtain a transformed reference model, the transformed reference model having coordinates in the common coordinate system.

18. Method according to claim 17, wherein the common coordinate system is the reference model coordinate system, the image reference system, or a third coordinate system.

19. Method according to claim 2, wherein the step of transforming uses tri-cubic interpolation methods.

20. Method according to claim 1, wherein the control elements are Bezier control points and step of transforming is based on a Bezier transformation.

21. Method according to claim 6, wherein the largest structural element of the reference model is represented by a unit cube which is associated with the boundary of the body, the largest structural element comprises an assembly of smaller structural elements, the unit cube being divided in smaller sub cubes, wherein each sub cube is assigned to one smaller structural element and a part within the body is associated with one or more sub cubes.

22. Method according to claim 21, wherein the largest structural element defines a reference boundary which reference boundary represents an approximation of the reference boundary of the body and the reference boundary of an assembly of one or more sub cubes represents an approximation of the boundary of a part within the body.

23. Method according to claim 1, wherein a part within the body has one or more associated reference meshes describing a boundary of said part in the reference model coordinate system.

24. Method according to claim 1, wherein a part within said body comprises a sub-part and a structural element representative of said part is a composition of sub structural elements, a sub structural element comprises control elements associated with a boundary representative of said sub part, the method further comprises:
k) a sub adjustment to adjust an overlaid boundary of the sub structural elements over the transformed image to approximate the boundary of said sub part within the body in the transformed image by adjusting coordinates of control elements associated with the sub structural element representative of the sub-part;
l) a sub transformation wherein the image area in the transformed image associated with the structural element comprising the sub part is processed and the edge of said image part remains unchanged in the transformed image and wherein image parts associated with coordinates of the adjusted overlaid boundary of the sub part are projected in the transformed image to the predetermined coordinates of the corresponding boundary of the sub structural element in the reference model coordinate system.

25. Method according to claim 1, further comprising storing data defining the transformation to enable transformation of spatial models associated with the reference model to real world coordinates to provide an anatomical model for the living being in real world coordinates.

26. Method according to claim 1, wherein the reference model comprises further electrical characteristics of a respective part within the body, the method further comprises determining a volume conduction model for use in algorithms that relate surface potentials to electrical events within the body.

27. Method according to claim 1, wherein the reference model comprises further mechanical and/or physiological characteristics of a respective part within the body, the method further comprises determining a mechanical and/or physiological model.

28. Method of linking coordinates of an image to coordinates of a reference model, the method comprising:
a) acquiring an input image representing a boundary of a body of a living being and a boundary of at least one part within said body in an image reference system, coordinates in the image having a relationship with a real world reference system;
b) acquiring a reference model representative of a reference living being describing in a reference model coordinate system the boundary of the body of the reference living being and the boundary of at least one part within said body, wherein the reference model comprises structural elements representative of the boundary of the body and the at least one part, a structural element having associated control elements, the control elements having predefined coordinates in the reference model coordinate system and defining the boundary of the structural element in the reference model coordinate system;
c) overlaying control elements and corresponding boundary of the structural element representative of the body on the input image, and assigning coordinates in the image reference system to the control elements;
d) a first adjustment to adjust the overlaid boundary of the structural element representative of the body on the input to approximate the boundary of the body of the living being in the input image by adjusting the coordinates of the control elements associated with said structural element in the image reference system;
e) a first transformation to transform the image area corresponding to the adjusted overlaid boundary to obtain an transformed image, the transformed image having coordinates in a transformed image coordinate system, wherein the transformed image coordinate system corresponds to the reference model coordinate system and the image parts associated with the coordinates of overlaid boundary being projected to the predefined coordinates of the corresponding boundary of the structural element in the reference model coordinate system;
a second adjustment to adjust an overlaid boundary of the structural elements of the at least one part of the reference model over the transformed image to approximate the boundary of the at least one part within the body in the transformed image by adjusting coordinates of control elements associated with the structural element representative of the at least one part in the reference model in the transformed image coordinate system;
g) a second transformation wherein image parts associated with coordinates of the adjusted overlaid boundary of the at least one part are projected in the transformed image to the predetermined coordinates of the corresponding boundary of the structural element representative of the boundary of the at least one part in the reference model coordinate system.

29. Method according to claim 28, wherein the first and second transformation uses tri-cubic interpolation methods.

30. Method according to claim 28, wherein the control elements are Bezier control points and the first and second transformation is based on a Bezier transformation.

31. Method according to claim 28, wherein the largest structural element of the reference model is represented by a unit cube which is associated with the boundary of the body, the largest structural element comprises an assembly of smaller structural elements, the unit cube being divided in smaller sub cubes, wherein each sub cube is assigned to one smaller structural element and a part within the body is associated with one or more sub cubes.

32. Method according to claim 31, wherein the largest structural element defines a boundary which boundary represents an approximation of the boundary of the body and the boundary of an assembly of one or more sub cubes represents an approximation of the boundary of a part within the body.

33. Method according to claim 28, wherein a part within the body has one or more associated reference meshes describing a boundary of said part in the reference model coordinate system.

34. Method according to claim 28, wherein a part within said body comprises a sub-part and a structural element representative of said part is a composition of sub structural elements, a sub structural element comprises control elements associated with a boundary representative of said sub part, the method further comprises:
h) a sub adjustment to adjust an overlaid boundary of the sub structural elements over the transformed image to approximate the boundary of said sub part within the body in the transformed image by adjusting coordinates of control elements associated with the sub structural element representative of the sub-part;
i) a sub transformation wherein the image area in the transformed image associated with the structural element comprising the sub part is processed and the edge of said image part remains unchanged in the transformed image and wherein image parts associated with coordinates of the adjusted overlaid boundary of the sub part are projected in the transformed image to the predetermined coordinates of the corresponding boundary of the sub structural element in the reference model coordinate system.

35. Method according to claim 28, further comprising j) storing data defining the first and second transformation to enable transformation of spatial models associated with the reference model to real world coordinates to provide an anatomical model for the living being in real world coordinates.

36. Method according to claim 35, wherein the reference model comprises further electrical characteristics of respective part within the body, the method further comprises determining a volume conduction model for use in algorithms that relate surface potentials to electrical events within the body.

37. System for linking coordinates of an image to coordinates of a reference model, the system comprising a processor and memory connected to the processor, wherein the system is arranged for performing the method according to claim 1.

38. A computer program product in a computer readable medium for use in a data processing system, for linking coordinates of an image to coordinates of a reference model, the computer program product comprising instructions arranged for, when executed on a processor, performing the method according to claim 1.
